(19) United States
(12) Patent Application Publication
(10) Pub. No.: US 2023/0130666 A1
(43) Pub. Date: Apr. 27, 2023

(54) MESH NETWORK DURING KEEP ALIVE IN WIRELESS BATTERY MANAGEMENT SYSTEM

(71) Applicant: TEXAS INSTRUMENTS INCORPORATED, Dallas, TX (US)

(72) Inventors: Ariton XHAFA, Plano, TX (US); Minghua FU, Plano, TX (US); Jonathan NAFZIGER, Dallas, TX (US)

(21) Appl. No.: 17/820,441

(22) Filed: Aug. 17, 2022

Related U.S. Application Data
(60) Provisional application No. 63/271,324, filed on Oct. 25, 2021.

(51) Int. Cl. H04W 52/02

(52) U.S. Cl. CPC H04W 52/0235

(57) ABSTRACT

A device includes a wireless transceiver coupled to a microcontroller. The microcontroller is configured to receive a first command from the wireless transceiver indicating an uplink allocation for the device, and in response to the first command, cause the wireless transceiver to turn ON at the beginning of the device's uplink allocation, send data to the wireless transceiver for wireless transmission, and cause the wireless transceiver to enter a low power mode after the data has been transmitted by the wireless transceiver. The microcontroller is also configured to receive a second command from the wireless transceiver to transition to a low power mode, and in response to the second command, send data to the wireless transceiver for wireless transmission during the uplink allocation for the device, and receive data from the wireless transceiver during uplink allocations for at least one other device.

### CROSS REFERENCE TO RELATED CASE

This patent application claims priority to U.S. Provisional Appl. No. 63/271,324, entitled “Enabling Mesh Network During Keep Alive in WBMS,” filed Oct. 25, 2021, and incorporated herein by reference.

### BACKGROUND

Increasingly, battery packs are being integrated into systems which traditionally were not powered by batteries, such as cars, houses, and even parts of the electrical grid. In addition to becoming more common, battery packs are becoming larger and more complex. For example, modern battery packs may comprise hundreds or thousands of battery cells. Monitoring the health and status of the individual cells in such battery packs helps to ensure continued proper operation of the system powered by such battery packs.

### SUMMARY

In one example, a device includes a wireless transceiver having a first interface; and a microcontroller having a second interface coupled to the first interface. The microcontroller is configured to receive a first command from the wireless transceiver indicating an uplink allocation for the device, and in response to the first command, cause the wireless transceiver to turn on at the beginning of the device's uplink allocation, send data to the wireless transceiver for wireless transmission, and cause the wireless transceiver to enter a low power mode after the data has been transmitted by the wireless transceiver. The microcontroller is also configured to receive a second command from the wireless transceiver to transition to a low power mode, and in response to the second command, send data to the wireless transceiver for wireless transmission during the uplink allocation for the device, and receive data from the wireless transceiver during uplink allocations for at least one other device.

### BRIEF DESCRIPTION OF THE DRAWINGS

For a detailed description of various examples, reference will now be made to the accompanying drawings in which:

FIG. 1 is a block diagram illustrating a battery management system (WBMS) having primary and secondary nodes, in accordance with an example.

FIG. 2 is another block diagram illustrating a WBMS, in accordance with an example.

FIG. 3 is a block diagram of a radio usable in the primary and secondary nodes of the WBMS, in accordance with an example.

FIG. 4 is a diagram of a superframe for a WBMS when the system (e.g., vehicle) in which the WBMS is operative is ON, in accordance with an example.

FIGS. 5A and 5B (collectively, FIG. 5) is a diagram of a superframe for a WBMS when the system in which the WBMS is operative is in a low power mode, in accordance with an example.

FIGS. 6A and 6B (collectively, FIG. 6) is a diagram of an alternative superframe for a WBMS when the system in which the WBMS is operative is in a low power mode, in accordance with an example.

The same reference numbers or other reference designators are used in the drawings to designate the same or similar (either by function and/or structure) features.

### DETAILED DESCRIPTION

Some systems are battery-operated and include large numbers of battery cells. Subsets of the battery cells may be packaged together in battery modules. Groups of interconnected battery modules represent a battery pack. Accordingly, a battery pack may have multiple battery cells, and in some cases may have hundreds or more of battery cells. Electric vehicles (EVs), for example, include rechargeable battery packs to operate the EV's electric motor and power various electronic components within the vehicle. In the context of an EV, the battery pack may provide a voltage of 400V, 800V or another voltage. Monitoring the individual battery cells for information such as such as voltage, current, temperature, register settings, etc., helps ensure the health and functionality of the overall battery pack. For example, battery cells may vary in terms of capacity and the rate of discharge (and/or charge). The cell-to-cell variation may result in imbalances in the state of charge between battery cells. Balancing techniques (e.g., passive cell balancing, active cell balancing) are available to more evenly balance the load (and/or power) across the cells and help improve the available capacity of the battery pack and increase its usable life. Passive cell balancing may dissipate excess charge in a given cell through a bleed resistor. Active cell balancing redistributes charge between individual cells during the charge and discharge cycles. As may be useful, a battery management system may be included to monitor and adjust the battery pack (e.g., cell balancing) of the system.

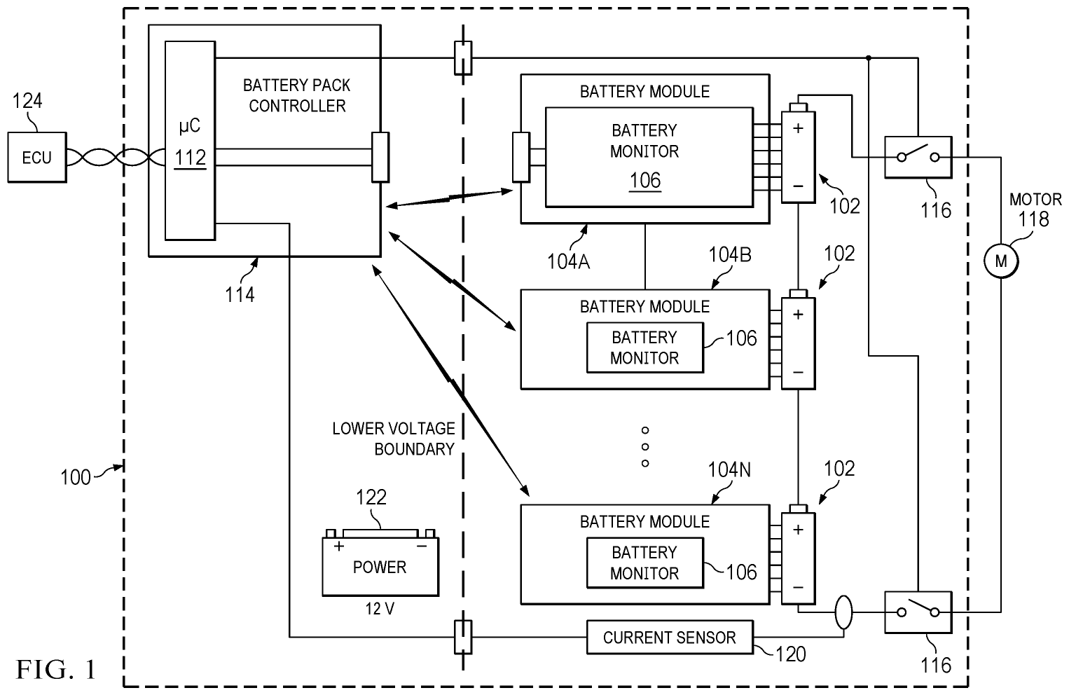

FIG. 1 is a block diagram illustrating a wireless battery management system (WBMS) 100, in accordance with aspects of the present disclosure. WBMS 100 is operative for providing power to a system such as an EV. In addition to the WBMS 100, the system includes a motor 118 (e.g., the electric motor to cause the EV to move) and an electric control unit (ECU) 124. The WBMS 100 includes battery modules 104A, 104B, . . . , 104N (collectively, battery modules 104) and a battery pack controller 114. The battery pack controller 114 is in wireless communication with each of the battery monitors 104. Each battery monitor 104 monitors and controls a respective set of battery cells 102. Each instance of battery cells 102 includes one or more cells (6 cells, 9 cells, 18 cells, etc.), and the connected groups of battery cells 102 represent the battery pack for the system (e.g., EV). Each set of battery cells 102 is coupled to a battery module 104. In other embodiments, the battery cells 102 are included within, and are part of, the battery module 104. The number N of battery modules 104 depends on the number of individual battery cells 102 that each module is capable of monitoring. The sets of battery cells may be coupled in series to produce a substantially high voltage (e.g., 400V, 800V, etc.). The battery pack controller 114 includes an interface (e.g., a controller area network (CAN) bus) to the ECU 124.

Each battery module 104 includes a battery monitor 106. Each battery monitor 106 may include an analog front-end coupled to the corresponding battery cells 102 to measure and collect information (e.g., voltage, current, charge status, temperature, etc.) about the battery cells 102. In this example, each battery monitor 106 is wirelessly coupled to the battery pack controller 114. A microcontroller 112 within the battery pack controller 114 may process and may provide the battery cell information of some or all of the cells 102 to the ECU 124.

Each battery monitor 106 collects and digitizes the information about its respective battery cells 102 and wirelessly transmits the digital information to the battery pack controller 114 for reception by the microcontroller 112. The microcontroller 114 may also be coupled to control inputs of switches 116 that couple the battery cells 102 to one or more motors 118 or other load devices. The microcontroller 112 may also be coupled to one or more other sensors, such as a current sensor 120, which may monitor the current being supplied by the battery pack to the motor 118. In this example, the battery pack controller 114 is powered by a battery 122 that is separate from the battery cells 102. Battery 122 may be, for example, a relatively low voltage battery, such as a 12V battery, while the voltage produced by the serially-connected sets of battery cells 102 may be a higher voltage (e.g., 400V, 800V, etc.).

When the system (e.g., EV) in which the WBMS 100 is operative is ON (e.g., the EV is being driven), both the battery pack controller 114 and the battery monitors 106 are active. While the system is in the ON-state, the battery monitors 104 wirelessly transmit their battery data to the battery pack controller 114. The battery pack controller 114 and/or the ECU 124 may monitor the state of the individual cells and perform various actions as desired. For example, the ECU 124 may detect that the voltage of certain cells 102 are different from each other, and respond by performing a cell balancing procedure such as a passive or active cell balancing process.

When the system in which the WBMS 100 is operative is OFF (e.g., the EV is parked but the EV is not connected to a charging system), the battery monitors 106 and the battery pack controller 114 may continue to be operative to monitor the cells 102. In this state, the battery cells 102 (which also power the battery monitor 106) and the lower voltage battery 122 may at least partially drain. The battery cells 102 have a much higher capacity, however, than lower voltage battery 122. Accordingly, the slow draining of the battery cells 102 represents a small percentage of the overall capacity of the cells 102. However, the draining of the battery 122 may be substantial. To avoid a substantial draining of the battery 122, the battery pack controller 114, which is powered by the lower voltage battery 122, may transition into a low power mode of operation (e.g., a sleep state). During this low power mode of operation, the battery pack controller 114 is not able to wirelessly receive and process battery cell data from the battery monitors 106. For example, the battery pack controller 114 may include a wireless radio which is turned OFF. The battery pack controller 114, however, may periodically wake up from its low power mode to receive wireless battery data from the monitors 106 and forward such data to the ECU 124. Due to the possibly relatively long periods of time that the battery pack controller 114 is in the low power mode, it may be desirable to continue monitoring the status of the battery cells even when the battery pack controller 114 is unable to receive and process battery cell data.

The embodiments described herein are directed to battery modules 104 that temporarily form a mesh network to exchange battery cell information amongst themselves without the assistance of the battery pack controller 114 (other than the battery pack controller 114 initiating the mesh network formation as it transitions to its low power mode). In an embodiment, the battery modules 104 may also perform a battery maintenance process (e.g., battery cell balancing) without the assistance of the battery pack controller 114 or ECU 124. A mesh network is a local area network topology in which the constituent nodes (the battery modules in this case) connect directly, dynamically, and non-hierarchically to as many other nodes as possible and cooperate with one another to efficiently route data between the nodes.

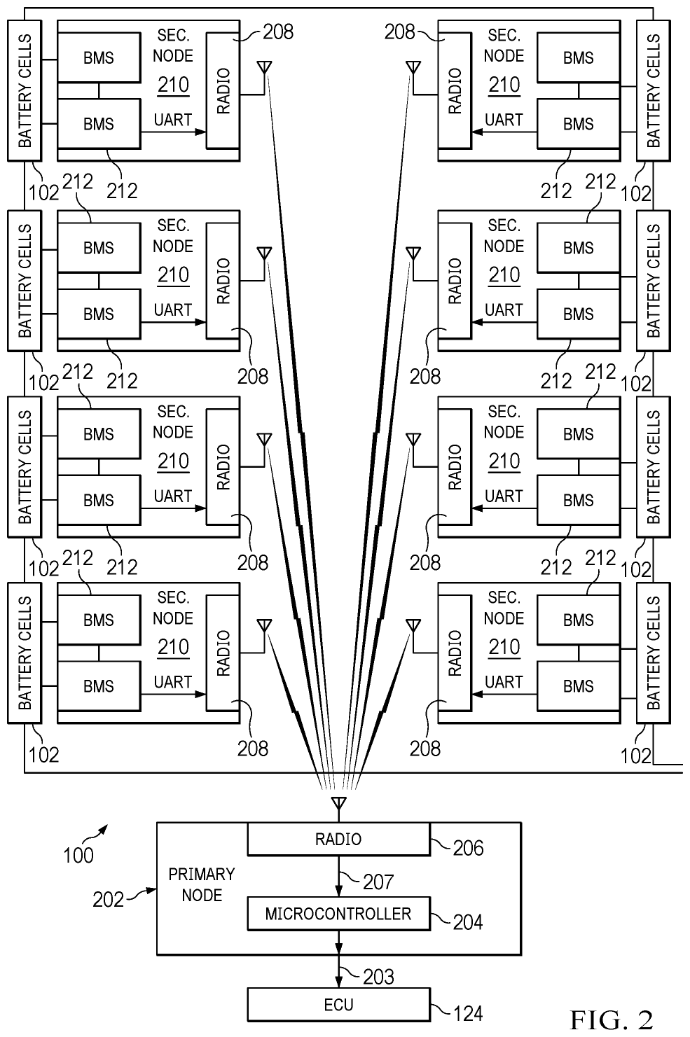

FIG. 2 is a block diagram illustrating an embodiment of WBMS 100, in accordance with aspects of the present disclosure. The WBMS 100 includes a primary node 202 that functions in a way similar to the battery pack controller 114. The primary node 202 includes a microcontroller 204 which is coupled to ECU 124, via, for example, a CAN bus 203. The microcontroller 204 may operate in a substantially similar way as microcontroller 112. The microcontroller 204 is coupled to a radio 206 via a digital communication interface 207 such as a universal asynchronous receiver-transmitter (UART) interface, serial peripheral interface (SPI), etc. The radio 206 is wirelessly coupled to the secondary nodes 210. The secondary nodes 210 represent the battery modules 104 of FIG. 1. Each secondary node 210 include a radio 208 for communicating with the primary node's radio 206. Each secondary node 210 also includes one or more battery monitoring systems (BMS) 212, which are coupled to the respective radio 208 via a UART or other type of electrical interface. Although two BMS's 212 are shown in each battery module 210 in FIG. 2, any suitable number of BMS's may be included in any given battery module (e.g., one or more). The radios 206 and 208 are capable of radio frequency (RF) wireless transmissions. Each secondary node 210 may be fabricated as a printed circuit board (PCB) on which the BMS's 212 and the radio 208 are mounted. In this configuration, each BMS 212 is fabricated as an integrated circuit (IC), and each radio 208 also is fabricated as an IC.

The BMS's 212 may be similar to battery monitors 106 and may include analog front-ends coupled to the battery cells 204 to measure and collect information (e.g., voltage, current, etc.) about the battery cells 102. This information may be sent, via the digital communication interface, to the respective radio 208 of the secondary node 210. The radio 208 of each secondary node 210 then wirelessly transmits the information to the primary node 202. In some cases, this wireless transmission may be performed according to a wireless battery management protocol, such as a WBMS protocol.

The wireless battery management protocol may define a set of wireless channels along with a set of rules for how information may be wirelessly transmitted for monitoring and managing the battery cells 102. In some cases, the wireless battery management protocol may utilize unlicensed frequency bands such as the 2.4 GHz, 5.8 GHz, etc. bands. Generally, a frequency band, such as the 2.4 GHz unlicensed frequency band, can be divided into a set of channels where each channel includes a set of frequency resources within a certain set of frequencies. The number of channels and the size of the channels may be determined based on the protocol. For example, the WBMS protocol may divide the 2.4 GHz unlicensed frequency band into a set of 40 channels where each channel is 2 MHz wide. As another example, IEEE 802.11 wireless networks may divide the same 2.4 GHz unlicensed frequency band into a set of 11 channels where each channel is 20 MHz wide.

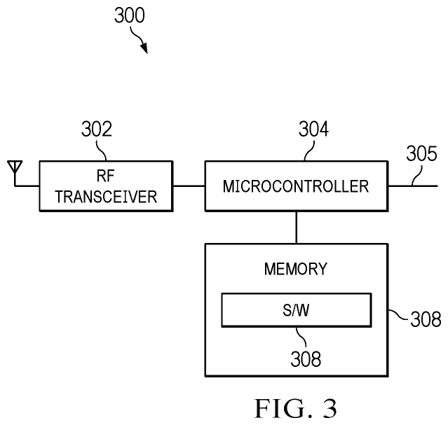

FIG. 3 is a block diagram of a radio 300, which may be used to implement either or both of radios 206 of the secondary nodes 210 and radio 208 of the primary node 202. In this example, radio 300 includes an RF transceiver 302, a microcontroller 304, and memory 308. Microcontroller 304 is coupled to the RF transceiver 302 and to memory 206. Memory 306 may store software 308 that is executable by microcontroller 304. The creation of the mesh network in the examples described herein may be implemented by the microcontroller 302 of radios 206 and 208 upon executing software 308. The software 308 provided in radios 208 of the secondary nodes 210 may be different than the software provided in radio 206 of the primary node 202.

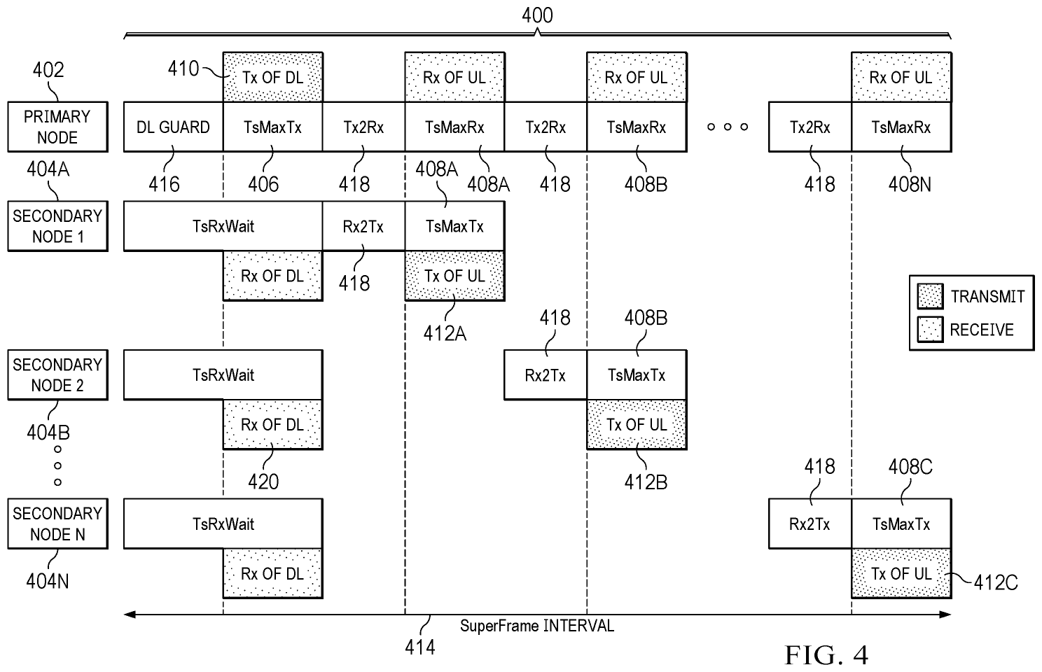

The primary node 202 and the secondary nodes 210 exchange information in accordance with a “superframe.” FIG. 4 is a superframe diagram 400 of a WBMS superframe 450 for the case in which the system in which the WBMS is operated is ON, and thus the battery pack controller 114 (primary node 202) are ON and capable of receiving wireless battery data from the battery monitors 106 (secondary nodes 210). The lefthand side of the superframe diagram 400 lists a primary node 402 and multiple secondary nodes 404A, 404B, . . . , 404N (collectively, secondary nodes 404). The primary node 402 may include, or be, the battery pack controller 114 of FIG. 1 or the primary node 202 of FIG. 2. The secondary nodes 404 may include, or be, the battery monitors 106 of FIG. 1 or the secondary nodes 210 of FIG. 2.

Along with channel sizing, the WBMS protocol further defines how communications between nodes may be performed. A WBMS network is directed by the primary node 402 which coordinates communications between the set of N secondary nodes 404. In one example, the primary node 402 coordinates communications for the WBMS network by defining communication intervals and allocating the intervals using the superframe 450 structure illustrated in the example of FIG. 4. The superframe 450 includes a downlink allocation 406 for the primary node 402 and uplink allocations 408A, 4086, . . . , 408N (collectively, uplink allocations 408) for secondary nodes 404A, 404B, . . . , 404N of the set of secondary nodes 404. In this example, the superframe 450 also includes a guard interval 416 prior to the downlink transmission 410, along with switching intervals 418 to provide time for the nodes to switch from a receive mode to a transmit mode, or vice versa. A superframe interval 414 is the amount of time to complete all transmissions for the superframe 450, including the guard interval 416. The time duration of the superframe interval 414 may vary from WBMS network to WBMS network based on the number of secondary nodes 404 in the WBMS network.

The primary node 402 transmits (410), during the downlink allocation 406 to the secondary nodes 404, allocation information about the uplink allocations 408 for the secondary nodes 404. The allocation information may include the set of channels (e.g., as indicated by a bit map) that may be used for the WBMS network along with a per-secondary node uplink allocation indicating when the respective secondary node 404A, 404B, . . . 404N may transmit 412A, 412B, . . . 412N to the primary node 402. In some cases, the allocation information may include additional information such as an acknowledgement for uplink transmissions from a previous superframe, an indication when the next superframe may begin, an adaptive frequency hopping countdown, etc. In some cases, each secondary node 404 wirelessly coupled to the primary node 402 is provided an individualized uplink allocation 408 to transmit information about the battery cells associated with the respective secondary node 404. The transmitted downlink information may include an indication (e.g., a command) to cause each secondary nodes 404 to turn ON its radio at the beginning of the uplink allocation for that secondary node and then turn OFF its radio at the end of the respective uplink allocation.

Each secondary node 404 gathers information about its respective battery cells and wirelessly transmits 412 such information to the primary node 402 during the uplink interval 408 assigned to the secondary node. For example, secondary node 2 404B receives 420 the downlink transmission 410 from the primary node 402 during the downlink allocation 406. In some cases, the secondary nodes 404 may determine the downlink allocation 406 time based on an indication from a previous superframe. The uplink transmissions 412 (and retransmissions, if any) by the secondary nodes 404 are completed within their respective uplink allocations 408, but the uplink transmissions may not occupy the entire uplink allocations 408.

After receiving the downlink transmission 410 from the primary node 403, each secondary node 404 may parse the allocation information received from the primary node 402 to determine timing information for the secondary node's uplink allocation 408 allocated to the secondary node. In some cases, information for how to locate the timing information associated with a specific secondary node from the allocation information may be exchanged during a WBMS network formation process.

During each uplink allocation, the secondary node to which that uplink allocation is assigned transmits its data for reception by the primary node 402. The other secondary nodes may turn off their radios so as not to receive and process the data from the secondary node transmitting the data. For example, during uplink allocation 412A, secondary node 404A transmits data but secondary nodes 404B through 404N do not receive such data because they have turned OFF their radios. Similarly, during uplink allocation 412B, secondary node 404B transmits data but secondary nodes 404A and 404C (not shown) through 404N do not receive such data, and so on. In one example, an uplink allocation is characterized by one secondary node transmitting data and only the primary node 402 receiving the data (the radios of the other secondary nodes are OFF).

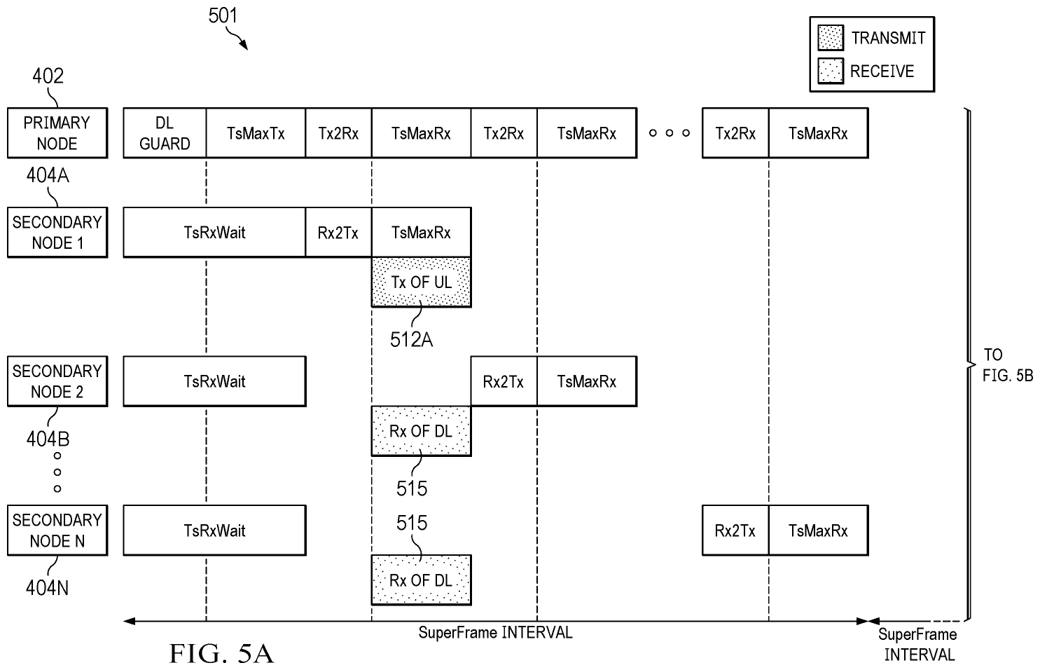

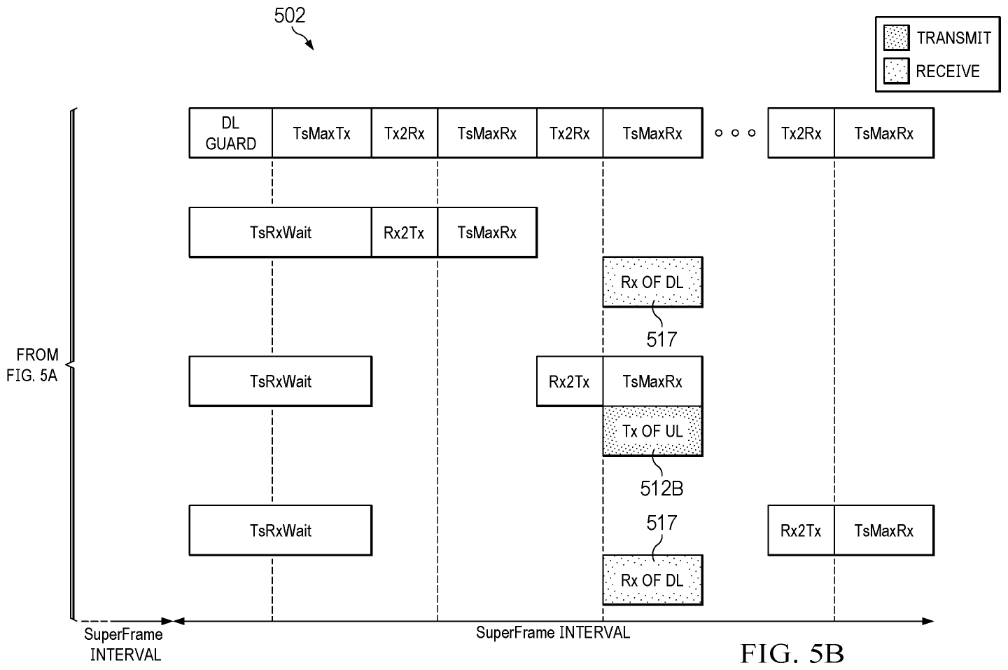

FIG. 5 is a sequence of superframes 501 and 502 for the WBMS for the case in which the system in which the WBMS is operative is OFF. When the system is OFF, the primary mode 402 (e.g., the battery pack controller 114, the primary node 202) may transition to a low power mode of operation, and thus does not transmit packets during its downlink allocation nor receive packets from secondary nodes during their respective uplink allocations. Just before, or as part of, entering the low power mode, the primary node 402 transmits a packet during its downlink allocation that indicates to the secondary nodes 404 that the primary node 402 is about to enter its low power mode. Responsive to that packet, the secondary nodes 404 form a mesh network as illustrated in the example of FIG. 5. The transmitted packet may include an indication (e.g., a command) to cause each secondary nodes 404 to turn ON its radio during the uplink allocations for that secondary node as well as all other secondary nodes that are part of the mesh network so that all of the secondary nodes 404 receive each secondary node's battery data. Each secondary node 404 continues to monitor its respective battery cells and transmit packets during the previously assigned uplink allocation for the secondary node. However, while operating as a mesh network, all of the secondary nodes maintain their radios in an ON state to receive the data transmitted by each secondary node during its uplink allocation.

For example, for superframe diagram 501 secondary node 404A transmits a data packet during its uplink allocation 512A while secondary nodes 404B through 404N receive (their radios are ON) the data packet as indicated by reference numeral 515. The primary node 402 is OFF (e.g., its radio is OFF) and does not receive the data packet transmitted by secondary node 404A. Superframe diagram 502 illustrates that secondary node 404B transmits a data packet during its uplink allocation 512B while the other secondary nodes receive (their radios are ON) the data packet as indicated by reference numeral 517. Accordingly, when one secondary node 404 transmits its battery data, at least some, and in some examples all, of the other secondary nodes receive that node's battery data.

FIG. 5 shows an example in which only one secondary node 404 transmits data during a superframe while the other nodes receive such data. In other embodiments, two or more secondary nodes 404 may transmit data during their respective uplink allocations within a single superframe.

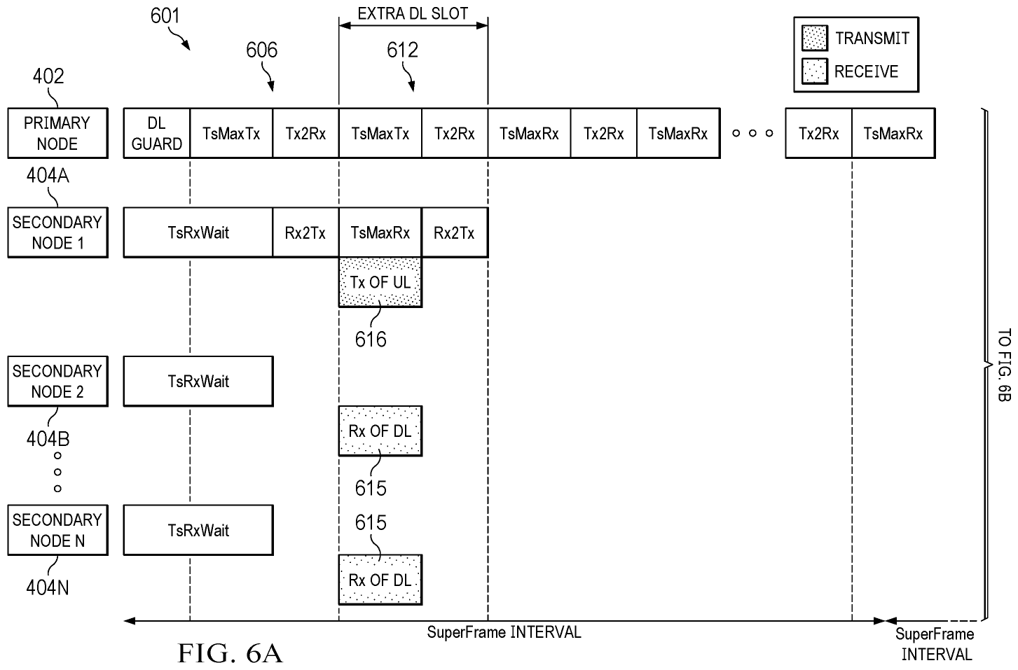

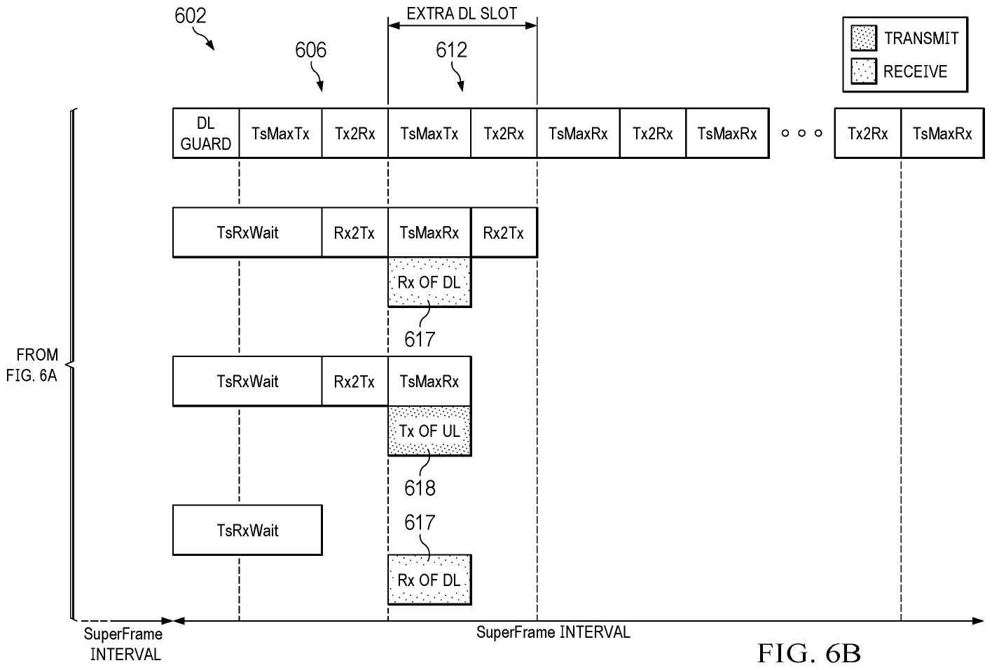

FIG. 6 is an example of the formation of a mesh network in which the secondary nodes share a downlink allocation separate from the primary node's downlink allocation 606 within each superframe 601, 602. Just before (or as part of) the primary node 402 entering the low power mode, the primary node 402 may transmit a command packet indicating to the secondary nodes that a second downlink allocation 612 is assigned into a particular time slot. During a downlink allocation, in turn each node transmits and the other nodes maintain their radios ON and thus receive the transmission. In this example, the time slot for the newly assigned downlink allocation 612 is immediately after downlink allocation 606, although downlink allocation 612 may be assigned elsewhere during the superframe. The nodes may be configured apriori the order in which they are to use the shared downlink, or the order may be specified by the primary node as part of the command packet.

The secondary nodes 404A through 404N take turns using the shared downlink allocation 612. For example, superframe 601 illustrates that secondary node 404A transmits a data packet 616 during shared downlink allocation 612, and secondary nodes 404B through 404N receive (their radios are ON) the data packet as indicated by reference numeral 615. In the next superframe 602, secondary node 404B transmits a data packet 618 during shared downlink allocation 612, and secondary nodes 404A and 404C (not shown) through 404N receive (their radios are ON) the data packet as indicated by reference numeral 617.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. A device, comprising:
a wireless transceiver; and
a microcontroller coupled to the wireless transceiver, the microcontroller configured to:
receive a first command from a primary node via the wireless transceiver indicating an uplink allocation for the device, and in response to the first command, cause the wireless transceiver to turn ON at a beginning of the device's uplink allocation, send data to the wireless transceiver for wireless transmission, and cause the wireless transceiver to enter a low power mode after the data has been transmitted by the wireless transceiver; and
receive a second command from the primary node via the wireless transceiver, and in response to the second command, send data to the wireless transceiver for wireless transmission during the uplink allocation for the device, and receive data from the wireless transceiver during an uplink allocation for at least one other device.

2. The device of claim 1, wherein the microcontroller is configured to send data to the wireless transceiver that is indicative of a battery cell.

3. The device of claim 1, wherein, in response to the second command, the microcontroller is configured to receive data from the wireless transceiver during uplink allocations for multiple other devices.

4. The device of claim 1, wherein:
in response to the first command, the microcontroller is configured to turn OFF the wireless transceiver after the data has been transmitted by the wireless transceiver; and
in response to the second command, the microcontroller is configured not to turn OFF the wireless transceiver during the uplink allocation for the least one other device.

5. A non-transitory storage device storing software that, when executed by a microcontroller, causes the microcontroller to:
receive a first command from a primary node via a wireless transceiver indicating an uplink allocation for the device, and in response to the first command, cause the wireless transceiver to turn ON at a beginning of the device's uplink allocation, send data to the wireless transceiver for wireless transmission, and cause the wireless transceiver to enter a low power mode after the data has been transmitted by the wireless transceiver; and
receive a second command from the primary node via the wireless transceiver, and in response to the second command, send data to the wireless transceiver for wireless transmission during the uplink allocation for the device, and receive data from the wireless transceiver during uplink allocations for at least one other device.

6. The non-transitory storage device of claim 5, wherein, when executed by the microcontroller, the software causes the microcontroller to receive data indicative of a battery cell and send the data indicative of the battery cell to the wireless transceiver.

7. The non-transitory storage device of claim 5, wherein, when executed by the microcontroller, the software causes the microcontroller to, in response to the second command, receive data from the wireless transceiver during uplink allocations for multiple other devices.

8. The non-transitory storage device of claim 5, wherein when executed by the microcontroller, the software causes the microcontroller to:
in response to the first command, turn OFF the wireless transceiver after the data has been transmitted by the wireless transceiver; and
in response to the second command, maintain ON the wireless transceiver during the uplink allocation for the least one other device.

9. A device, comprising:
a wireless transceiver; and
a microcontroller coupled to the wireless interface, the microcontroller configured to:
receive a first command from a primary node via the wireless transceiver during a first downlink allocation, the first command indicating an uplink allocation for the device, and in response to the first command, cause the wireless transceiver to turn ON at a beginning of the device's uplink allocation, send data to the wireless transceiver for wireless transmission, and cause the wireless transceiver to enter a low power mode after the data has been transmitted by the wireless transceiver; and
receive a second command from the primary node via the wireless transceiver during the first downlink allocation, the second command indicating a second downlink allocation to be shared by the device and at least one other device.

10. The device of claim 9, wherein the microcontroller is configured to send data to the wireless transceiver that is indicative of a battery cell.

11. The device of claim 9, wherein the microcontroller is configured to maintain its wireless transceiver ON during the second downlink allocation and to receive data from at the at least one other device during the second downlink allocation.

12. The device of claim 9, wherein the second command indicates a second downlink allocation to be shared by the device and multiple other devices.

13. A system, comprising:
a primary node having a first radio;
a plurality of secondary nodes each having a respective second radio;
wherein:
in a first mode of operation of the primary node, each of the plurality of secondary nodes is configured to wirelessly transmit data for reception by the primary node during an uplink allocation specific to each such secondary node while the other of the plurality of secondary nodes turn OFF their respective second radios; and
in a second mode of operation of the primary node, the plurality of secondary nodes are configured to form a mesh network and wirelessly exchange data between the plurality of secondary nodes.

14. The system of claim 13, wherein the system is an automobile.

15. The system of claim 13, wherein each of the plurality of second nodes is coupled to a battery cell, and the data includes a parameter of the battery cell.

16. The system of claim 13, wherein the second mode of operation of the primary node is a lower power mode than the first mode.

17. The system of claim 13, wherein:
while the primary node is in the first mode of operation, each of the plurality of secondary nodes is configured to receive network data from the primary node during a first downlink allocation associated with the primary node; and
while the primary node is in the second mode of operation, each of the plurality of secondary nodes is configured to share a second downlink allocation to exchange the data.

18. The system of claim 17, wherein the primary node is configured to indicate when a timeslot in which the second downlink allocation is to occur.

19. The system of claim 13, wherein:
while the primary node is in the first mode of operation, each of the plurality of secondary nodes is configured to receive network data from the primary node during a first downlink allocation associated with the primary node; and
while the primary node is in the second mode of operation, each of the plurality of secondary nodes is configured to transmit data during an uplink allocation specific to each such secondary node.

20. The system of claim 13, further comprising a battery pack including multiple battery cells, wherein subsets of the multiple battery cells are coupled to respective secondary nodes.
